(19) United States
(12) Patent Application Publication
(10) Pub. No.: US 2005/0023290 A1
(43) Pub. Date: Feb. 3, 2005

(54) Warewashing chemical dispenser

(75) Inventors: Yukio Kon, Tokyo (JP); Kenichi Ono, Tokyo (JP)

Correspondence Address: OLIFF & BERRIDGE, PLC, P.O. BOX 19928, ALEXANDRIA, VA, 22320, US

(73) Assignee: WELCO CO., LTD., Fuchu-shi (JP)

(21) Appl. No.: 10/735,672

(22) Filed: Dec. 16, 2003

(30) Foreign Application Priority Data
Jul. 28, 2003 (JP) 2003-280975

(51) Int. Cl. B67D 5/378

(52) U.S. Cl. 222/39; 222/64

(57) ABSTRACT

The invention relates to a warewashing chemical dispenser, enables a vacuum breaker to stably operate even at low pressures, makes individual systems and parts, which constitute a warewashing chemical dispenser, compact, and enables mounting of a container mounting and dismounting safety cut-off mechanism and an overflow preventive mechanism. A vacuum breaker for warewashing chemical dispensers, including an inlet path, an outlet path, a plate-shaped packing mounted on a lower end surface of a cap, and a valve disc provided on a vertical support shaft inserted through an air hole of the cap, the valve disc being moved up and down to be able to open and close the air hole, the vacuum breaker comprising an inlet passage provided in an inner chamber of a casing to form the inlet path substantially perpendicular to the outlet path, a vertical support shaft upper portion extended downwardly of a vertical support shaft of the valve disc, a vertical support shaft lower portion of the vertical support shaft formed to have a small diameter, a second O-ring mounted on an upper surface of the valve disc, the plate-shaped packing being mounted on a bottom surface of the cap opposed to the upper surface of the valve disc, and a cap dismounting lever provided centrally of an upper surface of the cap.

### BACKGROUND OF THE INVENTION

1. Field of the Invention

The present invention relates to a warewashing chemical dispenser for performing concentration control of detergent of solid, powder, granulated powder or the like.

2. Background Art

As conventional warewashing chemical dispensers, Japanese Patent No. 3145918 discloses arrangements of detergent dissolving units, detergent feed control systems, vacuum breakers, hot water control solenoid valves, or the like by means of wiring and piping work.

Detergents for automatic dish washers, food container washers, and plate washers are classified into liquid, solid, granulated powder and powder, and liquid among them is easy to feed with the use of a liquid pump while the mainstream for detergent of solid, granulated powder and powder resides in a method shown in FIG. 13, in which a system for feeding them after dissolution is constituted.

In FIG. 13, when an automatic dishwasher start to operate, hot water in a water heater 4 is first injected into a washing tank 10 from a rinsing nozzle 3 in an initial action, so that an appropriate amount of hot water is accumulated in the washing tank 10. At this time, a detergent dispensing control system 18 is actuated by a signal power source from a washer control unit 6 and concentration is measured by a concentration sensor 9. Control is performed in a manner to open a hot water control solenoid valve 19 until a detergent concentration becomes to a preset concentration.

Hot water supplied from a hot water inlet pipe 20 goes by way of a vacuum breaker 17 to be injected upward from a detergent dissolving nozzle 13 provided in a detergent dissolving system 12 to be poured into an opening 15a, which is mounted downward in a detergent container 15, to dissolve a detergent 16 in the detergent container 15 and the dissolved detergent pouringly falls via a solution outlet 21 in the washing tank 10 for replenishment. This operation is repeated until it will reach to the present detergent concentration.

Subsequently, a detergent solution 16a contained in the washing tank 10 is fed to a group of washing nozzles 2 by a washing circulating pump 7, and injected from nozzles 2a in the group of washing nozzles 2 to wash tableware 5, and garbage in hot water used in washing is removed by a mesh (illustration is omitted), the hot water being returned to the washing tank 10.

Further, hot water in a water heater 4 is fed by a rinsing pump 8 and injected from the rinsing nozzle 3 to rinse the tableware 5. Hot water having been used in rinsing is returned to the washing tank 10, and hot water increased at this time is drained through a drain pipe 22.

The concentration sensor 9 detects a detergent concentration decreased due to drainage and use in washing to replenish the detergent 16. This operation is repeatedly executed.

The vacuum breaker 17 serves as segmentation by forming an air layer to prevent a detergent composition, which has been permeated from a spray nozzle port of the detergent dissolving nozzle 13, to be permeated in the hot water control solenoid valve 19 and the hot water inlet pipe 20 when the hot water control solenoid valve 19 is closed.

When a container mounting and dismounting safety cut-off valve 14 is pushed by a side wall of the container 15 to be brought down at the time of mounting of the detergent container 15, it allows injection of hot water H from the detergent dissolving nozzle 13, and when the container 15 is removed, the valve serves to stop injection of hot water H from the detergent dissolving nozzle 13.

Subsequently, problems involved in the prior art will be described below.

(1) A conventional vacuum breaker 17 involves a problem that since both an inlet path 42 and an outlet path 45 are arranged in a single position on a bottom portion, an inlet pipe and a casing 54 are increased in diameter. Also, in recent years, kitchens abound in tenant buildings and available water pressure tends to be decreased. In coping with such tendency of pressure decrease, there has been made a demand for vacuum breakers that can act stably even at low pressures.

(2) The conventional vacuum breaker 17 mounts a single plate-shaped packing 38 between a valve disc 41 and a cap 47 to open and close an air hole 37 as shown in FIG. 14. In this case, when humidity or the like is generated on the packing 38, the valve disc 41 is attracted and does not fall, thus making opening and closing of the air hole 37 impossible. Also, there is a problem that lightening of the valve disc 41 increases the possibility that the valve disc 41 does not fall, with the result that the air hole 37 remains close to be unable to form an air layer, so that the vacuum breaker 17 is made inoperative.

(3) The vacuum breaker 17 involves a problem that dirt is generated inside by water passing inside, dust mixed in the water, or the like in use over a long term.

(4) With a conventional detergent dissolving system, both a detergent dissolving nozzle 13 and a solution outlet 21 are arranged centrally of the system, and a vacuum breaker 17 and a solenoid valve 19 are arranged outside as shown in FIG. 15, so that these units cannot be received compactly in the detergent dissolving system 12. Accordingly, there is caused a problem that piping becomes complex and there is a need of a space for a piping work.

(5) A conventional container mounting and dismounting safety cut-off valve 14 adopts means for pushing a container mounting and dismounting safety cut-off valve lever 14a against a side wall of a detergent container 15 to block a water flow. In recent years, however, there are caused problems that since the detergent container 15 is lightened and manufactured to be thin-walled, the container mounting and dismounting safety cut-off valve lever 14a bites into the detergent container 15 whereby the detergent container 15 will not be removed and the detergent container 15 is broken when being taken out. This is the same with the case of a powder adapter 57 shown in FIG. 16.

(6) Conventionally, there is caused a problem that in the case where clogging is caused between a solution outlet 21 and a detergent solution injection inlet 11 of an automatic dish washer 1, a detergent solution overflows from the detergent dissolving system 12 to leak. Also, it is required in view of a situation of clogging at the solution outlet 21 that the vacuum breaker 17 be installed in a higher position than a top of the detergent dissolving system 12 and piping be arranged outside whereby installation is not possible unless a large area for installation of the vacuum breaker 17 and so on can be ensured (see FIG. 13).

(7) Conventionally, there is caused a problem that when a container mounting and dismounting safety cut-off valve 14 and a container mounting and dismounting safety cut-off valve lever 14a are provided in a container receiving part 56 of a warewashing chemical dispenser 23 and a powder adapter 57 is mounted as shown in FIG. 16, some parts become impossible to dismount, or cannot exhibit the function of prevention of fountaining even when dismounting is possible.

(8) With the warewashing chemical dispenser 23, respective units and equipments, such as a detergent dissolving system 12, a detergent feed control system 18, a vacuum breaker 17, and a hot water control solenoid valve 19, and so on, in the warewashing chemical dispenser are individually installed in predetermined places in a kitchen or the like, and then the piping and wiring works are carried out in a spot such that piping and wiring are laid between these units and equipments. There is caused a problem that since such installation work is carried out in a spot, a term for the work becomes long and an increase in facility cost is caused. Also, while a site for installation needs a large area in terms of work, there is caused a problem that it is not easy to ensure a space for the installation work and the system cannot possibly be installed in some cases because a space for the installation work cannot be ensured specifically in the case of a store having a small space.

### SUMMARY OF THE INVENTION

Main object of the invention reside in enabling a vacuum breaker to stably operate even at low pressures, making individual systems and parts, which constitute a warewashing chemical dispenser, compact, and enabling mounting of a container mounting and dismounting safety cut-off mechanism and an overflow preventive mechanism.

The invention according to claim 1 provides a vacuum breaker for warewashing chemical dispensers, including an inlet path, an outlet path, a plate-shaped packing mounted on a lower end surface of a cap, and a valve disc provided on a vertical support shaft inserted through an air hole of the cap, the valve disc being moved up and down to be able to open and close the air hole, the vacuum breaker characterized by an inlet passage provided in an inner chamber of a casing to form the inlet path substantially perpendicular to the outlet path to afford fountaining a flow of hot water perpendicularly upward, a vertical support shaft upper portion extended downwardly of a vertical support shaft of the valve disc so that the valve disc can act stably even at low pressures, a vertical support shaft lower portion of the vertical support shaft formed to have a smaller diameter than that of the air hole, a second O-ring mounted on an upper surface of the valve disc, the plate-shaped packing being mounted on a bottom surface of the cap opposed to the upper surface of the valve disc, and a cap dismounting lever provided centrally of an upper surface of the cap and having an air port.

The invention according to claim 2 provides a warewashing chemical dispenser comprising a detergent dissolving nozzle arranged centrally of a container receiving part, a solution outlet arranged offset from a center of the container receiving part to form a storage section T in the warewashing chemical dispenser, and a detergent feed control circuit board received in the storage section T in the vicinity of the container receiving part and provided with a hot water control solenoid valve, a vacuum breaker, an indicator, and a buzzer, and wherein equipments requiring piping and wiring are received compactly in the warewashing chemical dispenser.

The invention according to claim 3 provides a container mounting and dismounting safety cut-off mechanism of a detergent dissolving system in a warewashing chemical dispenser, a container bearing part provided on a lower portion of a container receiving part and having substantially the same inclination as that of an inclined shoulder of a detergent container, a vertically moving shaft provided at an upper end thereof with an inclination portion corresponding to the inclined shoulder of the detergent container, a rod mounting a magnet to a lower end thereof and connected to a lower portion of the vertically moving shaft, a coil spring provided on the rod to make the vertically moving shaft vertically movable, and a detergent feed control circuit board, on which are arranged a magnetism detecting element arranged around a position of the magnet, and an indicator and a buzzer, which indicate and inform a state of feed control of a detergent, and wherein when the magnet is present in a detection range of the magnetism detecting element, feed control of the detergent is started and when the detergent container is removed and the magnet moves out from the detection range of the magnetism detecting element, a hot water control solenoid valve is closed after the feed control of the detergent is stopped, and simultaneously a situation of operation is informed by the indicator and the buzzer on the detergent feed control circuit board.

The invention according to claim 4 provides an overflow preventive mechanism of a detergent dissolving system in a warewashing chemical dispenser, comprising an overflow preventive sensor arranged in a container receiving part to be disposed in a little higher position than that of an upper surface of a detergent dissolving nozzle, and including two overflow preventive sensor electrodes, and wherein when a solution outlet is clogged and a detergent solution in a detergent dissolving system rises to contact between the two overflow preventive sensor electrodes, electric current flowing is detected, a signal thereof is transmitted to a microcomputer in a control circuit board to close a hot water control solenoid valve after stoppage of feed control, and simultaneously a situation of operation is informed by an indicator and a buzzer on a detergent feed control circuit board.

The invention according to claim 5 provides a detection mechanism of a detergent dissolving system in a warewashing chemical dispenser, comprising a protective cover pivotally mounted on one end of an upper opening through a hinge shaft, a powder adapter mounting thereto a depending piece, to which a magnet is mounted, and mounted to the protective cover, and a detection unit arranged on an upper portion of a container receiving part and receiving therein a magnetism detecting element in a position, which is opposed to the magnet when the powder adapter is received, and wherein when the protective cover is closed, the magnet is present in a detection range of the magnetism detecting element for starting of feed control, and when the protective cover is opened, a hot water control solenoid valve is closed after the magnet comes to a position outside the detection range of the magnetism detecting element to stop feed control, and simultaneously a situation of operation is informed by an indicator and a buzzer on a detergent feed control circuit board.

The invention according to claim 6 provides a warewashing chemical dispenser characterized in that the vacuum breaker according to claim 1, the warewashing chemical dispenser according to claim 2, the container mounting and dismounting safety cut-off mechanism according to claim 3, the overflow preventive mechanism of the detergent dissolving system according to claim 4, the detection mechanism, the detergent feed control system, and the hot water control solenoid valve in the detergent dissolving system according to claim 5 are received compactly and collectively in the warewashing chemical dispenser.

### BRIEF DESCRIPTION OF THE DRAWINGS

FIG. 1 is a view illustrating a warewashing chemical dispenser as a whole according to the invention.

FIG. 2 is a partial, cross sectional view showing a vacuum breaker before actuation.

a is a partial, cross sectional view showing the vacuum breaker at the time of actuation, and b is an exploded, perspective view showing the vacuum breaker.

FIG. 4 is a cross sectional view showing a detergent dissolving system.

FIG. 5 is a partial, cross sectional view showing a warewashing chemical dispenser provided with an overflow preventive mechanism and a container mounting and dismounting safety cut-off mechanism according to the invention.

FIG. 6 is a side, cross sectional view showing a warewashing chemical dispenser according to the invention.

FIG. 7 is a front, cross sectional view showing a warewashing chemical dispenser according to the invention.

FIG. 8 is a cross sectional view showing a state when a detergent container is inserted into the warewashing chemical dispenser.

FIG. 9 is a cross sectional view showing a state when the detergent container is taken out from the warewashing chemical dispenser.

FIG. 10 is a cross sectional view showing a detection mechanism in the warewashing chemical dispenser when a powder adapter is used.

FIG. 11 is a cross sectional view showing the detection mechanism in the warewashing chemical dispenser when the powder adapter is used.

FIG. 12 is a cross sectional view showing the detection mechanism in the warewashing chemical dispenser when the powder adapter is used.

FIG. 13 is a view illustrating a conventional warewashing chemical dispenser as a whole.

FIG. 14 is a cross sectional view showing a conventional vacuum breaker.

FIG. 15 is a view illustrating a conventional detergent dissolving nozzle.

FIG. 16 is a cross sectional view showing a conventional container mounting and dismounting safety cut-off valve and its vicinity.

### EMBODIMENTS

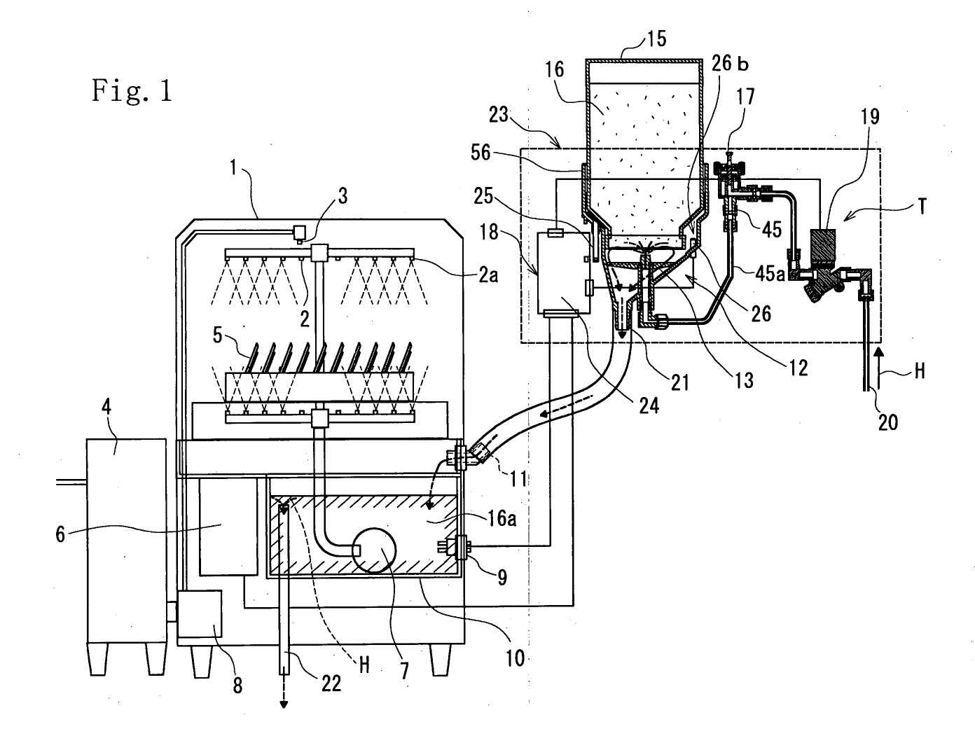

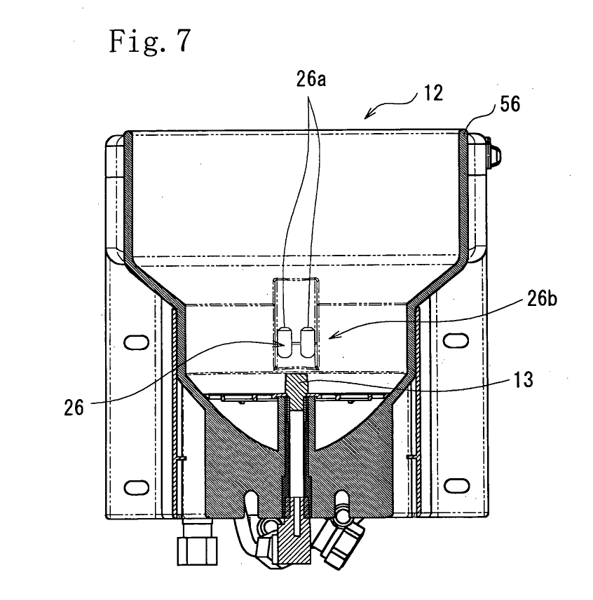

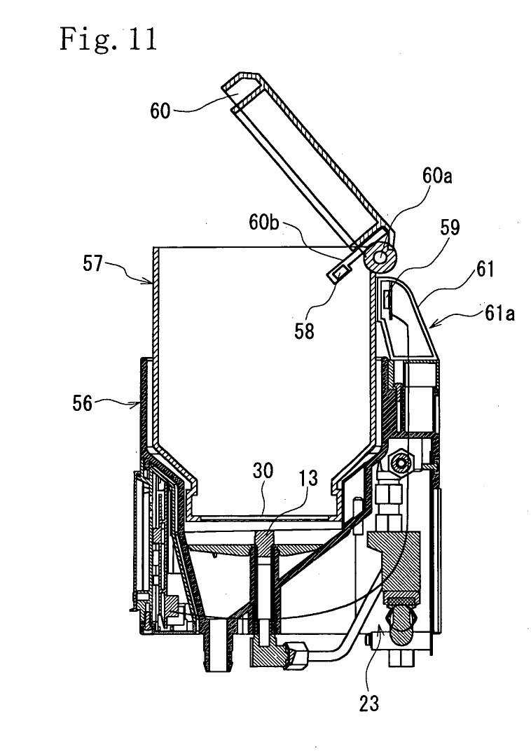

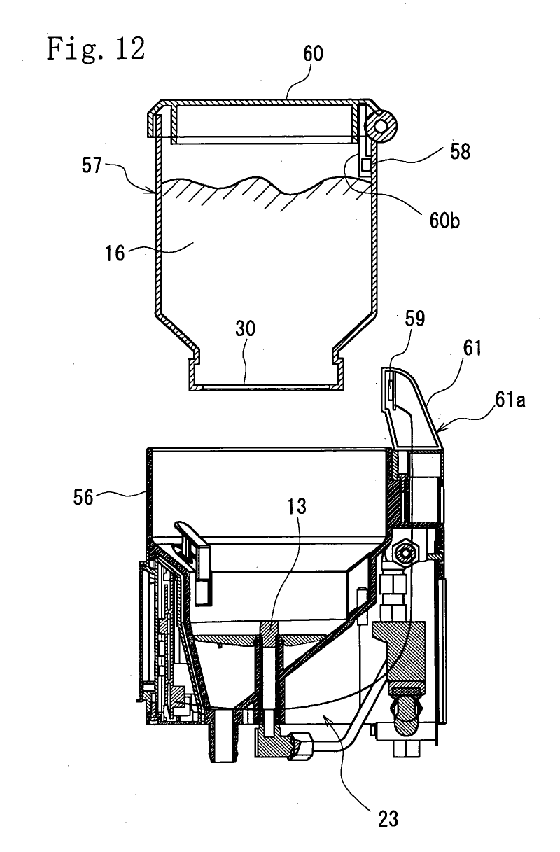

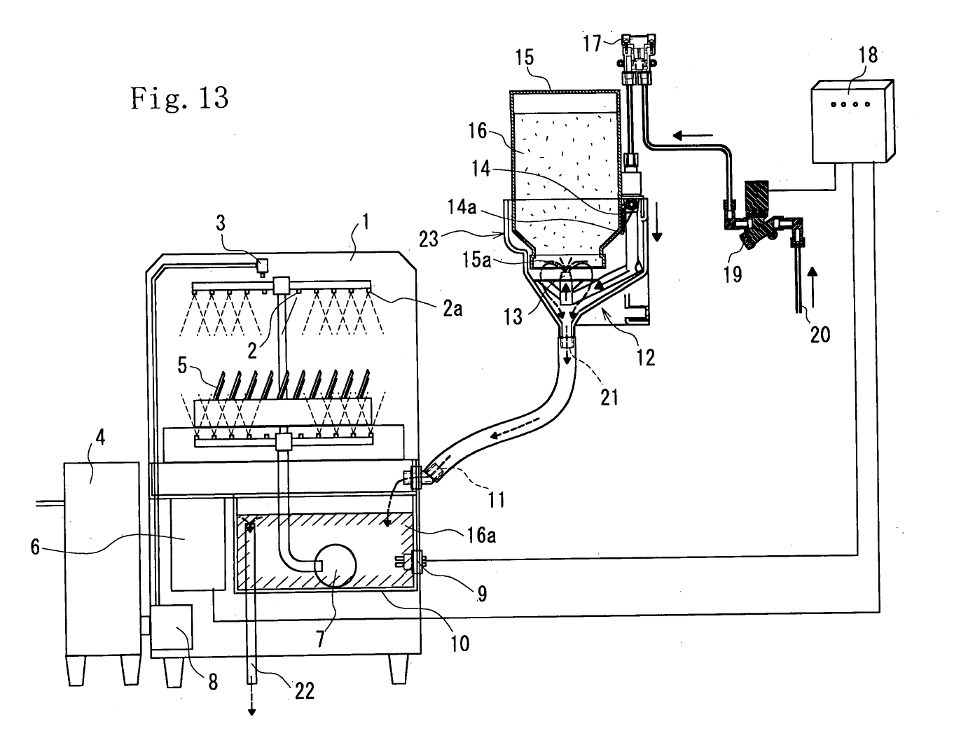

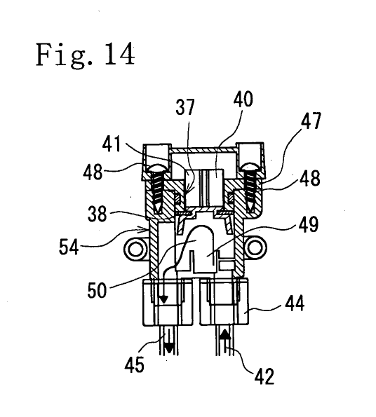

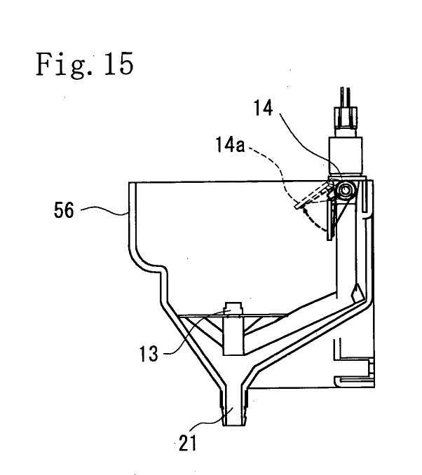

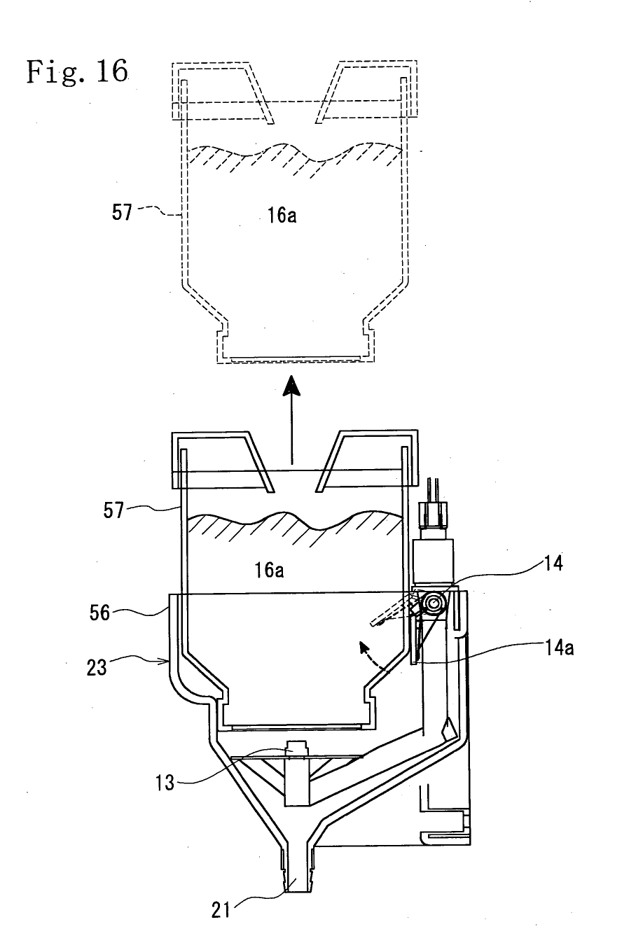

Embodiments of the invention will be described with reference to FIGS. 1 to 12.

In FIG. 1, when an automatic dish washer 1 starts to operate, hot water in a water heater 4 is first injected into a washing tank 10 from a rinsing nozzle 3 in an initial action, so that an appropriate amount of hot water is accumulated in the washing tank 10. At this time, a detergent feed control system 18 is actuated by a signal power source from a washer control unit 6 and concentration is measured by a concentration sensor 9. Control is performed in a manner to open a hot water control solenoid valve 19 until a detergent concentration reaches a preset concentration.

Hot water H supplied from a hot water inlet pipe 20 goes by way of a vacuum breaker 17 to be injected upward from a detergent dissolving nozzle 13 provided in a detergent dissolving system 12 to be poured into an opening 15a, which is mounted downward in a detergent container 15, to dissolve a detergent 16 in the detergent container 15 and the dissolved detergent pouringly falls via a solution outlet 21 in the washing tank 10 for replenishment. This operation is repeated until it will reach to the present detergent concentration.

Subsequently, a detergent solution 16a contained in the washing tank 10 is fed to a group of washing nozzles 2 by a washing circulating pump 7, and injected from nozzles 2a in the group of washing nozzles 2 to wash tableware 5, and garbage in hot water used in washing is removed by a mesh (illustration is omitted), the hot water being returned to the washing tank 10.

Further, hot water H in the water heater 4 is fed by a rinsing pump 8 and injected from the rinsing nozzle 3 to rinse the tableware 5. Hot water having been used in rinsing is returned to the washing tank 10, and hot water H increased at this time is drained through a drain pipe 22.

The concentration sensor 9 in the washing tank 10 detects a detergent concentration decreased due to drainage and use in washing to replenish the detergent 16. This operation is repeatedly executed.

### First Embodiment

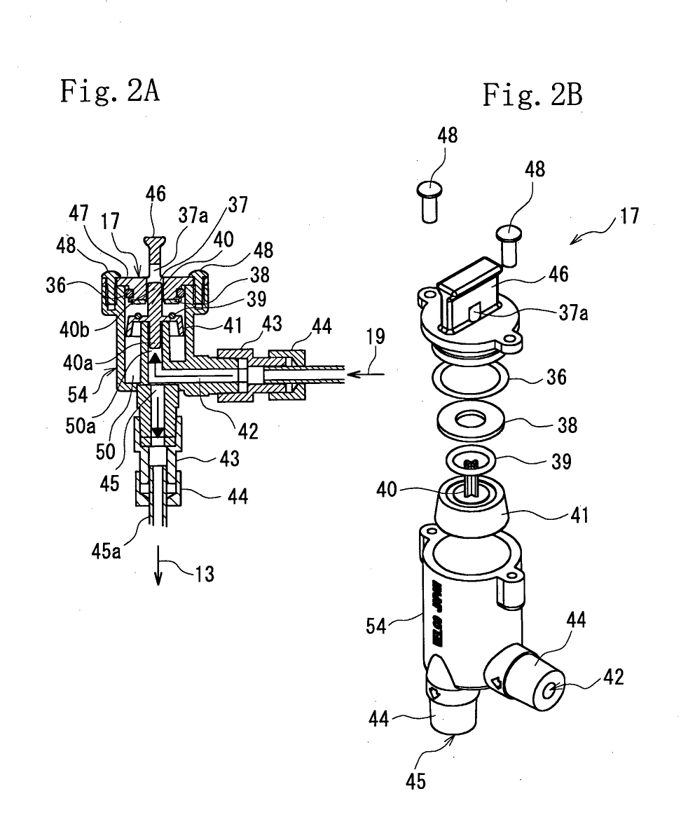

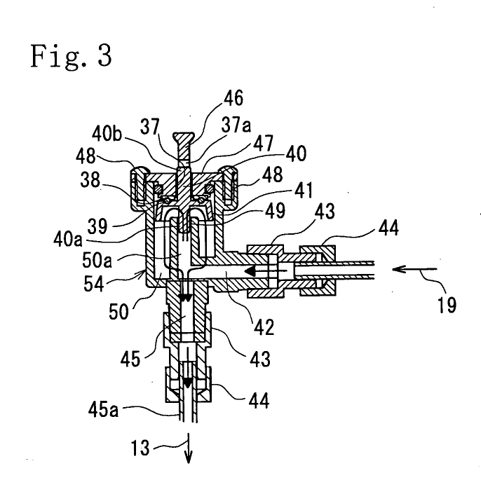

First, a vacuum breaker according to a first embodiment (claim 1) of the invention will be described with reference to FIGS. 2 and 3.

A vacuum breaker 17 according to the invention comprises an inlet path 42 and an outlet path 45, a cap.47 mounts a plate-shaped packing 38 on a lower end surface thereof, a valve disc 41 is provided on a vertical support shaft 40 inserted into an air hole 37 of the cap 47, and the valve disc 41 is moved up and down to be able to open and close the air hole 37.

Provided in an inner chamber 50 in a casing 54 of the vacuum breaker 17 is an inlet passage 50a to make the inlet path 42 substantially perpendicular to the outlet path 45 so as to permit flow of hot water to fountain perpendicular upward. Also, a vertical support shaft lower portion 40a is extended downwardly of the vertical support shaft 40 of the valve disc 41 so that the valve disc 41 can be stably operated even at low pressures, and a vertical support shaft upper portion 40b of the vertical support shaft 40 is formed to have a little smaller diameter than an inside diameter of the air hole 37. Further, a second O-ring 39 is mounted on an upper surface of the valve disc 41, and the plate-shaped packing 38 is mounted on a bottom surface of the cap 47 opposed to the upper surface of the valve disc 41. Also, a cap dismounting lever 46 having an air port a37 is provided centrally of an upper surface of the cap 47.

The cap 47 is fixed to the casing 54 by mount screws 48, and a first O-ring 36 is arranged on the cap 47.

Also, pipe joints 43 are fixed to tip ends of the inlet path 42 and the outlet path 45, and compression nuts 44 are mounted on tip ends of the pipe joints 43.

The vacuum breaker 17 constructed in the above manner causes fountaining vertically from a fountain port 49 when hot water is supplied, and the water pressure thereof pushes the valve disc 41 upward as shown in FIG. 3. And when the valve disc 41 is pushed up, the packing 38 mounted on the upper surface of the valve disc 41 blocks the air hole 37. Since a detergent dissolving nozzle 13 is connected to the outlet path 45 via a pipe 45a, load is applied on the outlet path and pressure in the inner chamber 50 rises to push the valve disc 41.

Subsequently, when feed of hot water is stopped, water flow disappears in the inlet path 42 and hot water in the pipe flows out from the detergent dissolving nozzle 13 whereby pressure in the outlet path 45 decreases to permit the valve disc 41 to fall by dead weight and an air is poured to lower the water level in the outlet path 45 and the inner chamber 50. Thereby, an air layer is formed between the inner chamber 50 and an interior of the outlet path 45.

Accordingly, since the valve disc 41 can be stably assured in position at the time of fountaining, a stable operation is made possible even in the case the valve disc 41 is lightened and even at low pressure.

Also, close contact of a circular-shaped curved surface of the second O-ring 39 makes it possible to enlarge a contact area to afford an improvement in sealing quality. Also, when pressure decreases, a configuration of the circular-shaped curved surface of the second O-ring 39 causes a peeling-off action to prevent adhesion of the plate-shaped packing 38 and the valve disc 41, thus enabling making an action of the valve disc 41 very smooth.

### Second Embodiment

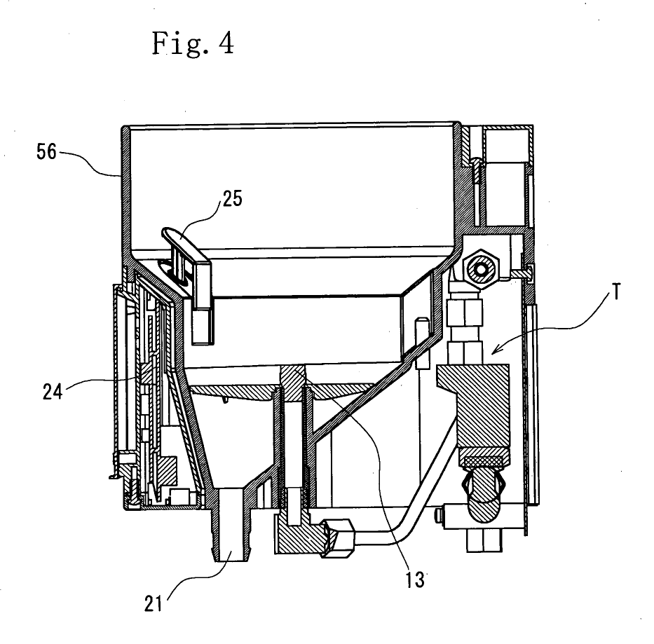

A warewashing chemical dispenser 23 according to a second embodiment (claim 2) of the invention is described with reference to FIGS. 4, 5 and 6.

The warewashing chemical dispenser 23 according to the second embodiment of the invention serves to store equipments, which constitute the warewashing chemical dispenser 23 and for which piping and wiring are necessary, compactly in the warewashing chemical dispenser 23.

The warewashing chemical dispenser comprises a detergent dissolving system having a detergent dissolving nozzle 13 substantially centrally thereof, the detergent dissolving nozzle 13 being arranged substantially centrally of a container receiving part 56, and a solution outlet 21 is arranged offset from the center of the container receiving part 56, a storage section T being formed in the warewashing chemical dispenser 23.

And received in the storage section T in the vicinity of the container receiving part 56 is a hot water control solenoid valve 19, the vacuum breaker 17, and a detergent feed control circuit board 24 provided with an indicator 51 and a buzzer 5, and arranged in the warewashing chemical dispenser 23 are associated systems and members.

### Third Embodiment

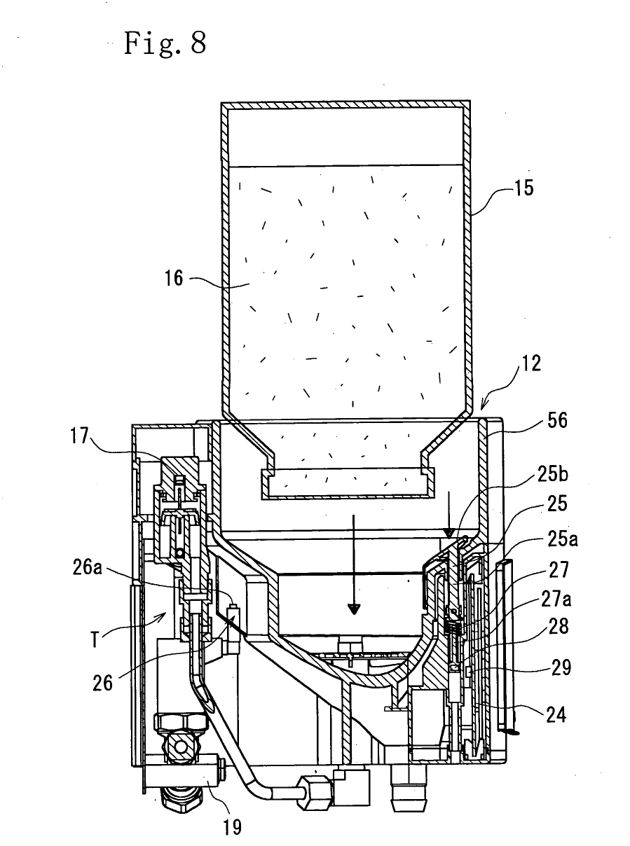

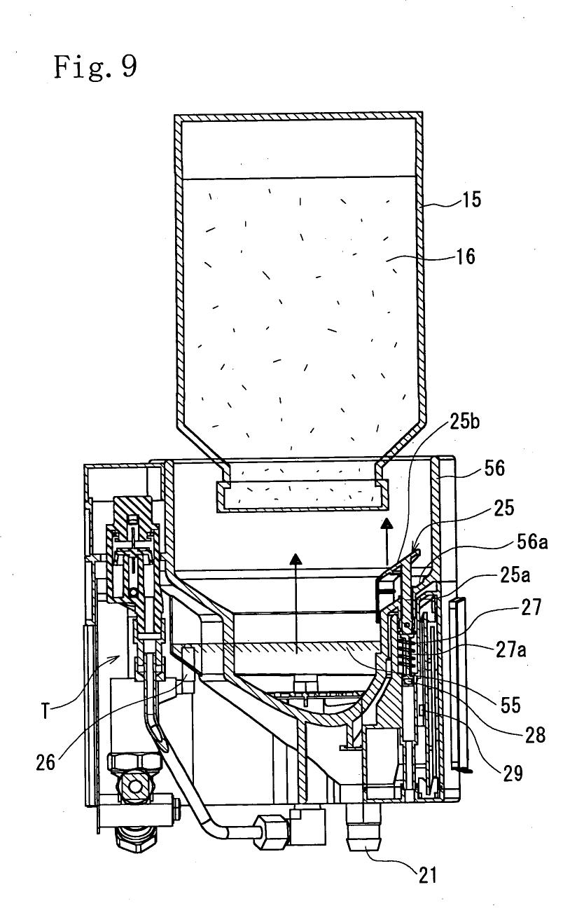

A container mounting and dismounting safety cut-off mechanism 25 in the warewashing chemical dispenser 23 according to a third embodiment (claim 3) of the invention will be described with reference to FIGS. 8 and 9.

With the container mounting and dismounting safety cut-off mechanism 25 of a detergent dissolving system in the warewashing chemical dispenser according to the third embodiment of the invention, a container bearing part 56a having substantially the same inclination as that of an inclined shoulder of a detergent container 15 is provided in a lower portion of the container receiving part 56, and the container bearing part 56a comprises a rod 27a mounting at a lower end thereof a magnet 28 and connected to a lower portion of a vertically moving shaft 25a provided at an upper end thereof with an inclination portion 25b corresponding to the inclined shoulder of the detergent container 15, and a coil spring 27 provided on the rod 27a to make the vertically moving shaft 25a vertically movable.

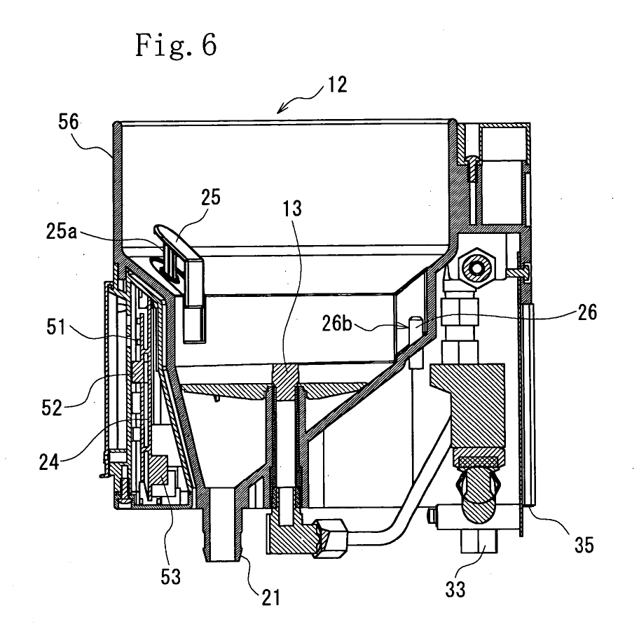

Also, a detergent feed control circuit board 24 is disposed around a position of the magnet 28 to mount thereon a magnetism detecting element 29, an indicator 51 for indicating and informing a state of detergent feed control, and a buzzer 53. And when the magnet 28 is present in a detection range of the magnetism detecting element 29, feed control of a detergent is started, and when the detergent container 15 is removed and the magnet 28 is moved outside the detection range of the magnetism detecting element 29, the hot water control solenoid valve 19 is closed after feed control of the detergent is stopped, and a present state is simultaneously informed by the indicator 51 and the buzzer 53 on the detergent feed control circuit board 24. An adjustment switch 52 for control is arranged on the detergent feed control circuit board 24 as shown in FIG. 6.

When the detergent container 15 is inserted into the container bearing part 56a, the coil spring 27 contracts, and the magnet 28 is moved downward, and when the moved magnet 28 enters the detection range of the magnetism detecting element 29 mounted on the detergent feed control circuit board 24 disposed in a control board mount casing (illustration is omitted) to give a judgment that the detergent container 15 is present, a signal to that effect is taken into a microcomputer in a control circuit board to lead to a judgment that a feeding action is possible, thus starting the feed control. When the detergent container 15 is removed, the coil spring 27 expands to push up the container mounting and dismounting safety cut-off mechanism 25. At this time, the magnet comes out from the detection range of the magnetism detecting element 29, it is judged that the detergent container 15 is absent, and the hot water control solenoid valve 19 is closed after the feed control is stopped. Simultaneously with this, a present state of operation is informed by the indicator 51 and the buzzer 53 arranged on the detergent feed control circuit board 24.

### Fourth Embodiment

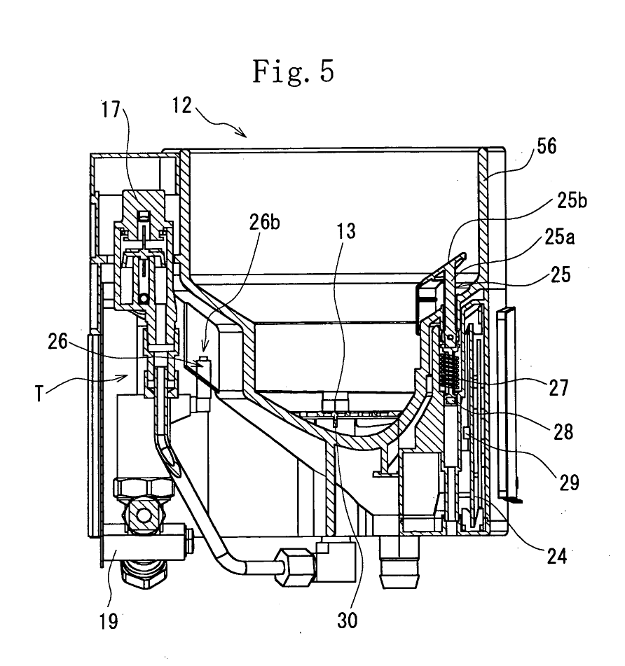

An overflow preventive mechanism 26b in the detergent dissolving system 12 of the warewashing chemical dispenser 23, according to a fourth embodiment (claim 4) of the invention will be described with reference to FIGS. 5 to 7.

With the overflow preventive mechanism 26b in the detergent dissolving system according to the fourth embodiment, two overflow preventive sensor electrodes 26a of an overflow preventive sensor 26 are arranged in the container receiving part 56 to be arranged in a little higher position than an upper surface of the detergent dissolving nozzle 13, and when the solution outlet 21 is clogged and a detergent solution 55 in the detergent dissolving system 12 rises in level, electric current flowing between the overflow preventive sensor electrodes 26a when the detergent solution 55 contacts between the two overflow preventive sensor electrodes 26a is detected, a signal to that effect is transmitted to the microcomputer in a control circuit board (illustration is omitted) to stop the feed control, and simultaneously a situation of operation is informed by the indicator 51 and the buzzer 53 arranged on the detergent feed control circuit board 24. The reference numeral 33 in FIG. 6 indicates a hot water inlet.

In the case where the solution outlet 21 is clogged in a configuration, in which electric current flowing between the overflow preventive sensors electrodes 26a can be detected, the detergent solution 55 in the detergent dissolving system 12 rises in level. When the detergent solution 55 contacts with the overflow preventive sensor electrodes 26a, electric current flows there between and detected. A signal to that effect is taken into the microcomputer in the control circuit board to lead to a judgment of abnormality, the hot water control solenoid valve 19 is closed after the feed control is stopped, and simultaneously a situation is informed by the indicator 51 and the buzzer 53 arranged on the detergent feed control circuit board 24, which have been described in the third embodiment.

The overflow preventive mechanism 26b prevents the detergent solution 55 from rising above a position of the overflow preventive sensor 26. As a result, it becomes unnecessary to install the vacuum breaker 17 in a high position in the same manner as conventionally, and the warewashing chemical dispenser 23 can be integrated (internal mounting) as a whole.

### Fifth Embodiment

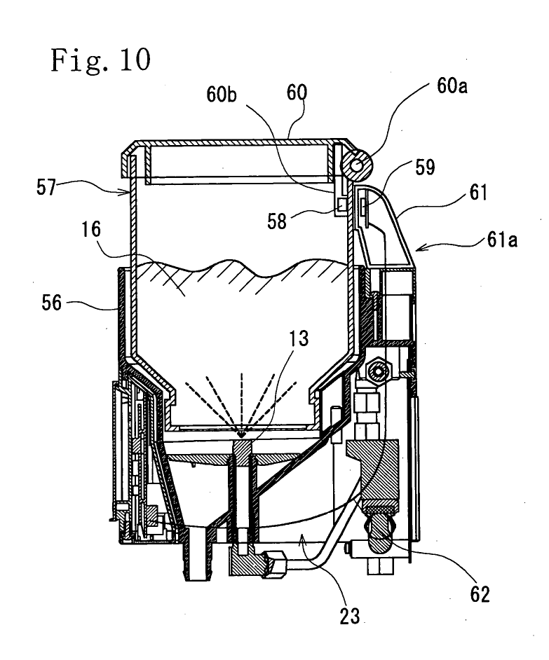

A detection mechanism 61a of a detergent dissolving system in the warewashing chemical dispenser 23 according to a fifth embodiment (claim 5) of the invention will be described with reference to FIGS. 10 to 12.

A protective cover 60 is pivotally mounted through a hinge shaft 60a on one end of an upper opening of a powder adapter 57, and a depending piece 60b fixing thereto a magnet 58 is mounted on the protective cover 60. Also, a detection unit 61 receiving therein a magnetism detecting element 59 is arranged in a position opposed to the magnet 58 when the powder adapter 57 is received in an upper area of a container receiving part 56, so that when the protective cover 60 is closed, the magnet 58 comes to a position inside a detection range of the magnetism detecting element 59 for starting of feed control, when the protective cover 60 is opened, the hot water control solenoid valve 19 is closed after the magnet 58 moves to a position outside the detection range of the magnetism detecting element 59 to stop feed control, and simultaneously a situation of operation is informed by the indicator 51 and the buzzer 53 arranged on the detergent feed control circuit board 24.

Since the detection unit 61 receiving therein the magnetism detecting element 59 is mounted, a signal line 62 is connected to the detergent feed control circuit board 24 at the time of mounting. When the protective cover 60 is closed, the magnet is positioned in the detection range of the magnetism detecting element 59 to automatically lead to a judgment of closing of the cover and a signal to that effect is taken into the microcomputer in the control circuit board to lead to a judgment that the feeding action is possible, thus starting the feed control. When the protective cover 60 is opened, the magnet comes out of the detection range of the magnetism detecting element 59 to automatically lead to a judgment of opening of the cover, and the hot water control solenoid valve 19 is closed after the feed control is stopped, and simultaneously a present situation of operation is informed by the indicator 51 and the buzzer 53 arranged on the detergent feed control circuit board 24. There is arranged a detergent fall preventing mesh 30 for preventing the detergent from falling from an opening 15a.

With the embodiment, the detection unit 61 and the powder adapter 57 are configured to be completely separated from each other, so that it is possible to replenish the detergent 16 in a state, in which the powder adapter 57 is dismounted, and a work is possible at hand. Also, the work can be easily done even in the case where the warewashing chemical dispenser is mounted in a high position.

### Sixth Embodiment

A warewashing chemical dispenser according to a sixth embodiment (claim 6) of the invention will be described with reference to FIGS. 1, 4, 8 and 10 to 12.

With the warewashing chemical dispenser according to the invention, the vacuum breaker 17 according to the first embodiment, the detergent feed system 23 for the warewashing chemical dispenser according to the second embodiment, the container mounting and dismounting safety cut-off mechanism 25 according to the third embodiment, the overflow preventive mechanism 26b of the detergent dissolving system according to the fourth embodiment, the detection mechanism 61a, the detergent feed control system 18, and the hot water control solenoid valve 19 in the detergent dissolving system according to the fifth embodiment can be received compactly and collectively in the warewashing chemical dispenser 23.

The invention produces the following effects.

According to the invention of claim 1, (1) the inlet path of the vacuum breaker is arranged substantially perpendicular to the outlet path and the respective paths are reduced to a small pipe diameter, so that the vacuum breaker can be made compact as a whole.

(2) Since positional stability at the time of fountaining can be ensured and the valve disc is lightened, the valve disc can act stably even at low pressures. While the prior art becomes inoperative at 0.08 Mpa, the novel art is made operable at up to 0.03 Mpa.

(3) Since a peripheral surface of the second O-ring is pushed against the plate-shaped packing to closely contact therewith, the both are increased in contact area to enable achieving an improvement in sealing quality. Also, when the inner chamber is reduced in pressure, the peripheral surface of the second O-ring acts to peel the peripheral surface of the second O-ring off the plate-shaped packing, thus preventing adherence of the packing to enable smoothing actuation of the valve disc.

(4) Since the cap dismounting lever affording mounting and dismounting is provided just above the air hole, the cap dismounting lever is dismounted to afford easily cleaning an interior of the vacuum breaker and maintaining a clean state over a long term.

According to the invention of claim 2, a vacuum breaker, a solenoid valve, and other members, which are conventionally connected to a detergent dissolving system by means of wiring and piping works, can be received compactly in a warewashing chemical dispenser, wiring and piping works are dispensed with, and the warewashing chemical dispenser can be installed readily in a short time in a job site.

According to the invention of claim 3, even when a detergent container, which is lightened and manufactured to be thin-walled, is used, accidents such as biting into the detergent container to lead to non-coming-off, breakage of the container, or the like are not generated, and so it is possible to readily mount and dismount the detergent container from a detergent dissolving system.

According to the invention of claim 4, a detergent solution is prevented from rising above a position, in which the overflow preventive sensor of the overflow preventive mechanism is installed. Also, while it is conventionally required in view of a situation, in which a solution outlet 21 is clogged, that a vacuum breaker 17 be installed in a higher position than a top of a detergent dissolving system 12 and an installation work be done by means of external piping, it becomes unnecessary to install the vacuum breaker in a high position and integration can be achieved by internal mounting.

According to the invention of claim 5, since the detection unit is constructed to be completely separated from the powder adapter, it is possible to replenish a detergent in a dismounted state, and the work therefor is possible at hand.

According to the invention of claim 6, a detergent dissolving system, a detergent feed control system, a vacuum breaker, a hot water control solenoid valve, and so on, piping and installing works of which systems and constituent members thereof are individually executed, are collected compactly in a single location to enable manufacturing a warewashing chemical dispenser. Also, since the warewashing chemical dispenser is formed to be compact and piping is arranged inside, work operations become unnecessary and facility cost can be reduced. Also, installation can be simply made even in stores having a small space and installation is possible in any site.

1. A vacuum breaker for warewashing chemical dispensers, including an inlet path, an outlet path, a plate-shaped packing mounted on a lower end surface of a cap, and a valve disc provided on a vertical support shaft inserted through an air hole of the cap, the valve disc being moved up and down to be able to open and close the air hole, the vacuum breaker characterized by an inlet passage provided in an inner chamber of a casing to form the inlet path substantially perpendicular to the outlet path to afford fountaining a flow of hot water perpendicularly upward, a vertical support shaft upper portion extended downwardly of a vertical support shaft of the valve disc so that the valve disc can act stably even at low pressures, a vertical support shaft lower portion of the vertical support shaft formed to have a smaller diameter than that of the air hole, a second O-ring mounted on an upper surface of the valve disc, the plate-shaped packing being mounted on a bottom surface of the cap opposed to the upper surface of the valve disc, and a cap dismounting lever provided centrally of an upper surface of the cap and having an air port.

2. A warewashing chemical dispenser comprising a detergent dissolving nozzle arranged centrally of a container receiving part, a solution outlet arranged offset from a center of the container receiving part to form a storage section T in the warewashing chemical dispenser, and a detergent feed control circuit board received in the storage section T in the vicinity of the container receiving part and provided with a hot water control solenoid valve, a vacuum breaker, and a detergent feed control circuit board provided with an indicator and a buzzer, and wherein equipments requiring piping and wiring are received compactly in the warewashing chemical dispenser.

3. A container mounting and dismounting safety cut-off mechanism of a detergent dissolving system in a warewashing chemical dispenser, a container bearing part provided on a lower portion of a container receiving part and having substantially the same inclination as that of an inclined shoulder of a detergent container, a vertically moving shaft provided at an upper end thereof with an inclination portion corresponding to the inclined shoulder of the detergent container, a rod mounting a magnet to a lower end thereof and connected to a lower portion of the vertically moving shaft, a coil spring provided on the rod to make the vertically moving shaft vertically movable, and a detergent feed control circuit board, on which are arranged a magnetism detecting element arranged around a position of the magnet, and an indicator and a buzzer, which indicate and inform a state of feed control of a detergent, and wherein when the magnet is present in a detection range of the magnetism detecting element, feed control of the detergent is started and when the detergent container is removed and the magnet moves outside from the detection range of the magnetism detecting element, a hot water control solenoid valve is closed after the feed control of the detergent is stopped, and simultaneously a situation of operation is informed by the indicator and the buzzer on the detergent feed control circuit board.

4. An overflow preventive mechanism of a detergent dissolving system in a warewashing chemical dispenser, comprising an overflow preventive sensor arranged in a container receiving part to be disposed in a little higher position than that of an upper surface of a detergent dissolving nozzle, and including two overflow preventive sensor electrodes, and wherein when a solution outlet is clogged and a detergent solution in a detergent dissolving system rises to contact between the two overflow preventive sensor electrodes, electric current thus flowing is detected, a signal thereof is transmitted to a microcomputer in a control circuit board to close a hot water control solenoid valve after stoppage of feed control, and simultaneously a situation of operation is informed by an indicator and a buzzer on a detergent feed control circuit board.

5. A detection mechanism of a detergent dissolving system in a warewashing chemical dispenser, comprising a protective cover pivotally mounted on one end of an upper opening through a hinge shaft, a powder adapter mounting thereto a depending piece, to which a magnet is mounted, and mounted to the protective cover, and a detection unit arranged on an upper portion of a container receiving part and receiving therein a magnetism detecting element in a position, which is opposed to the magnet when the powder adapter is received, and wherein when the protective cover is closed, the magnet is present in a detection range of the magnetism detecting element for starting of feed control, and when the protective cover is opened, a hot water control solenoid valve is closed after the magnet comes to a position outside the detection range of the magnetism detecting element to stop feed control, and simultaneously a situation of operation is informed by an indicator and a buzzer on a detergent feed control circuit board.

6. (Canceled)
